(19) United States
(12) Patent Application Publication
(10) Pub. No.: US 2024/0018054 A1
(43) Pub. Date: Jan. 18, 2024

(54) PART MADE FROM CMC AND METHOD FOR MANUFACTURING SUCH A PART

(71) Applicants: SAFRAN CERAMICS, Le Haillan (FR); IRT ANTOINE DE SAINT EXUPERY, Toulouse (FR)

(72) Inventors: William ROS, Moissy-Cramayel (FR); Simon Lucien René THIBAUD, Moissy-Cramayel (FR); Maxime BOX, Le Haillan (FR); Christophe HIRONDELLE, Moissy-Cramayel (FR)

(73) Assignees: SAFRAN CERAMICS, Le Haillan (FR); IRT ANTOINE DE SAINT EXUPERY, Toulouse (FR)

(21) Appl. No.: 18/255,030

(22) PCT Filed: Nov. 22, 2021
(86) PCT No.: PCT/FR2021/052054

§ 371 Date: May 30, 2023

(30) Foreign Application Priority Data
Nov. 30, 2020 (FR) 2012373

(51) Int. Cl. C04B 35/573; C04B 35/80

(52) U.S. Cl. CPC C04B 35/573; C04B 35/80; C04B 2235/5244; C04B 2235/5252; C04B 2235/6565

(57) ABSTRACT

Method for manufacturing a part made from CMC for improving control of the step of densifying the part, and intermediate part for implementing said method, the intermediate part comprising a reinforcement, a matrix comprising a ceramic material, and at least one insert, which is made from a material different from that of the reinforcement and the matrix and which is designed to promote migration of liquid silicon within the intermediate part during a step of densifying the intermediate part.

### TECHNICAL FIELD

This disclosure relates to a method for manufacturing a part made from CMC, that is to say from ceramic matrix composite material, for improving control of the step of densifying the part. It also relates to an intermediate part for implementing this method as well as a part made from CMC obtained by this method.

Such a manufacturing method can in particular be used in the field of aeronautics in order to manufacture parts capable of withstanding high temperatures. They may in particular be sectors of a cylindrical member of a turbomachine, such as an aircraft turbojet engine, and very particularly sectors of a turbine ring, to mention only these examples.

### PRIOR ART

Some parts of a turbomachine are exposed to particularly high temperatures. This is in particular the case of the parts forming the turbine(s) of the turbomachine, for example the sectors of the rings allowing to produce the outer flow path of the turbine.

In order to withstand these very high temperatures, the ring sectors are made from CMC. In a typical manufacturing method for this type of part, a preform is woven using ceramic fibers, for example silicon carbide (SiC). This preform is then shaped in a shaper then an interphase is deposited on the surface of the ceramic fibers, by CVI method for example (Chemical Vapor Infiltration). Secondly, a slurry comprising ceramic particles, for example SiC particles, suspended in a solvent, is injected into the preform; once the solvent has been removed by drying, the ceramic particles thus deposited are sintered in order to form a matrix enclosing the preform. An intermediate part having a certain porosity is then obtained. A densification step is then carried out by infiltration then solidification of a liquid densification material, in general liquid silicon, in the intermediate part.

However, the silicon being denser in the solid state than in the liquid state, its cooling and its solidification leads to the exit of a portion of the liquid silicon in the form of drops solidifying on the surface of the part, thus forming solid silicon nodules. These nodules then cause significant difficulties since they change the dimensions of the part beyond the tolerances and degrade the adhesion of any surface coating subsequently deposited. In addition, the removal of these nodules by sandblasting or machining is slow, laborious, and therefore expensive; it can further affect the material health of the final part.

Consequently, in order to combat the appearance of such nodules, certain solutions have been considered. One of them aims at changing the composition of the densification material or of the ceramic slurry, for example by adding diamond particles, sources of carbon which will consume the excess silicon to form SiC. However, it is not always possible or desirable to change the composition of the slurry in this way.

Another option consists in providing a sacrificial layer of ceramic slurry all around the intermediate part in order to protect the final part, and in particular its reinforcement, during sandblasting or machining of nodules. However, naturally, such an option entails a significant overconsumption of raw materials and requires complete machining of the final part, which is long and tedious.

Finally, a third option seeks to control the cooling front of the silicon within the part by using an oven fitted with several areas the temperatures of which can be controlled independently of each other. However, the production and control of such an oven is complex and expensive.

There is therefore a real need for a method for manufacturing a part made from CMC which improves control of the step of densifying the part and which is devoid, at least partially, of the disadvantages inherent in the aforementioned known methods.

### DISCLOSURE OF THE INVENTION

This disclosure relates to an intermediate part made from CMC composite material, comprising a reinforcement, a matrix including a ceramic material, and at least one insert, which is made from a material different from that of the reinforcement and the matrix and which is designed to promote migration of liquid silicon within the intermediate part during a step of densifying the intermediate part.

Thus, thanks to such a configuration, the excess liquid silicon tends to migrate in the direction of the inserts and therefore to concentrate around the latter. Consequently, during the cooling, the silicon nodules tend to form preferentially at the surface of the areas traversed by such inserts.

Consequently, it is possible to dispose the inserts so as to control the areas where nodules appear, failing necessarily to seek to prevent their formation. Therefore, it will be possible to dispose the inserts in such a way as to group the nodules in insensitive areas of the final part, that is to say areas that can be machined easily, without significant impact on the operation of the part, even areas in which the tolerances are greater and allow the presence of such nodules without it being necessary to carry out machining or sandblasting. The cost and cycle time of the manufacturing method can therefore be reduced.

Thus, this solution leaves the densification method unchanged and in particular does not require any material composition adjustment or any additional complex tooling. In addition, the behavior of the final part, as well as its possible coatings, is thus improved.

In certain embodiments, the intermediate part comprises at least one working area intended, once the part has been finalized, to be in contact with a working fluid of a turbomachine, said at least one insert being provided in an area of the intermediate part that is not a working area. Preferably, no insert of this type is provided in a working area. In this way, the work surfaces of the part, that is to say those exposed to the highest temperatures and moreover likely to receive coatings, can be obtained without, or practically without, any nodule of notable size. The need to resort to sandblasting or machining of these particularly sensitive areas is therefore greatly reduced.

In certain embodiments, at least one insert is a unidirectional element. Preferably, this is the case for at least 50% of the inserts, for at least 90% of the inserts, or even for all the inserts. This allows to direct the flow of silicon in a preferred direction along the insert.

In certain embodiments, at least one insert is a thread or a set of threads. Preferably, this is the case for at least 50% of the inserts, for at least 90% of the inserts, or even for all the inserts. The production of such a wire is indeed particularly easy.

In certain embodiments, at least one insert is a solid or hollow cylinder. Preferably, this is the case for at least 50% of the inserts, for at least 90% of the inserts, or even for all the inserts. Such shapes are also easy to make.

In certain embodiments, the diameter of at least one insert is comprised between 0.1 and 1 mm. Preferably, this is the case for at least 50% of the inserts, for at least 90% of the inserts, or even for all the inserts. It is recalled in this respect that, in a metric space, the diameter of a non-empty portion A, here the section of the insert, is the upper bound of the distances between any two points of A.

In certain embodiments, the length of at least one insert is greater than or equal to 5 mm. Preferably, this is the case for at least 50% of the inserts, for at least 90% of the inserts, or even for all the inserts.

In certain embodiments, at least one insert is discontinuous. Preferably, this is the case for at least 50% of the inserts, for at least 90% of the inserts, or even for all the inserts.

In certain embodiments, the intermediate part comprises several inserts organized according to an array having at least two distinct orientations, preferably at least three distinct orientations. Such an array allows to promote migration of the liquid silicon on the scale of a widened area of the intermediate part, or even on the scale of the entire part. It is thus possible to more easily drain the excess silicon in the entire part and to direct it towards certain desired areas.

In certain embodiments, at least one insert is partially or totally fusible or consumable during a step of densifying the intermediate part. Preferably, this is the case for at least 50% of the inserts, for at least 90% of the inserts, or even for all the inserts. The term “fusible” is understood to mean the capacity of the insert to melt, that is to say to change to the liquid state, at the temperature of the densification step, for example 1400° C. “Consumable” means the capacity of the insert to be consumed by one or more chemical reactions occurring under the physico-chemical conditions of the densification step. In either case, this allows to create cavities in the intermediate part into which the silicon will migrate by capillarity. In addition, since the volume available for the silicon inside the part is increased, the total volume of the nodules is also reduced.

In certain embodiments, at least one insert has a coefficient of thermal expansion different from that of the matrix, preferably higher. Preferably, this is the case for at least 50% of the inserts, for at least 90% of the inserts, or even for all the inserts. In this way, a phenomenon of differential expansion is brought about which will generate the appearance of micro-cracks in the intermediate part, facilitating the migration of the silicon by capillarity. Given the tiny size of these micro-cracks, their impact on the mechanical strength of the final part is minimal; in any case, the appearance of these micro-cracks is limited to the areas of the inserts, that is to say potentially to non-sensitive areas of the part.

In certain embodiments, at least one insert is made of oxide ceramic material, preferably having a melting point above 1400° C. Preferably, this is the case for at least 50% of the inserts, for at least 90% of the inserts, or even for all the inserts. Such materials offer strong compatibility with the materials of the reinforcement and the matrix of the intermediate part.

In certain embodiments, at least one insert is made of alumina. Preferably, this is the case for at least 50% of the inserts, for at least 90% of the inserts, or even for all the inserts. On the one hand, alumina is an oxide ceramic material compatible in particular with SiC. On the other hand, alumina is a material that is partially consumable during the densification step, with a portion of its aluminum share dissolving in the silicon and a portion of its oxygen share degassing outside of the part.

In certain embodiments, the reinforcement is a woven preform, which is preferably 3D woven. 3D weaving allows in particular to obtain fibrous reinforcements with complex geometries made in one piece, thus ensuring very good mechanical resistance to the final part.

In certain embodiments, the reinforcement is made of ceramic material, preferably silicon carbide (SiC). However, any type of ceramic fiber could also be used and in particular carbon fibers or else a mixture of fibers.

In certain embodiments, the matrix is made of silicon carbide (SiC). However, any type of ceramic powder could also be used and in particular non-oxide, refractory or ultra-refractory ceramics, based on Si, Ti, Zr, HF, C, N such as C, B4C, TiC, ZrC, or TiSi2.

In certain embodiments, the intermediate part is of the turbine ring type. In particular, it may be a turbine ring sector. More generally, the intermediate part comprises a flow path portion and at least one fastening portion, for example in the shape of one or more flanges.

This disclosure also relates to a method for manufacturing a CMC composite part, comprising the steps of: providing an intermediate part according to any one of the preceding embodiments; and densifying the intermediate part by penetration of liquid silicon into the intermediate part.

In certain embodiments, the step of providing the intermediate part comprises a step of weaving a preform, the weaving step comprising the simultaneous three-dimensional weaving of two types of fibers the materials of which are different, the first type of fiber forming the three-dimensional structure of the preform intended to form the reinforcement of the intermediate part and the second type of fiber forming at least one insert of the intermediate part.

In certain embodiments, the method comprises, during the densification step, a sub-step of controllably cooling the intermediate part. Such a step allows to control the cooling of the liquid silicon in order to maximize its migration close to the inserts.

In certain embodiments, a homogeneous temperature is imposed on the entire intermediate part during the cooling sub-step. In particular, the imposition of a temperature gradient or distinct temperature areas is not required. This avoids the use of complex tooling.

In certain embodiments, the cooling sub-step begins at an initial temperature comprised between 1000 and 1500° C., preferably comprised between 1400 and 1500° C.

In certain embodiments, the cooling sub-step comprises at least, or consists of a cooling ramp of less than 5° C./min, preferably less than 2° C./min, more preferably less than 0.5° C./min. Such reduced speeds allow sufficient time for the liquid silicon to migrate and concentrate at the inserts. One or more temperature stages can also be provided.

In certain embodiments, the cooling ramp continues up to a temperature comprised between 1250 and 1350° C. At this temperature, nodule formation is complete or nearly complete. A second cooling sub-step can then take place until ambient temperature is reached.

In certain embodiments, the second cooling sub-step is a controlled cooling faster than the first cooling sub-step but slower than a free cooling. In particular, it can comprise, or consist of, a cooling ramp comprised between 200° C./h and 500° C./h. In this way, the internal stresses in the material are limited and the service life of the internal elements of the oven is extended.

In certain embodiments, the second cooling sub-step is an accelerated cooling, comprising, or consisting of, a temperature ramp comprised between 700° C./h and 1500° C./h. In this way, gains in terms of cycle time are possible.

In certain embodiments, the second cooling sub-step is a free cooling.

In certain embodiments, the manufacturing method comprises, after the cooling step, a machining step during which nodules of solidified silicon are machined.

This disclosure also relates to a part made from CMC composite material, obtained by a manufacturing method according to any one of the preceding embodiments. It may in particular be a turbine part, a ring sector for example.

This disclosure also relates to a turbomachine comprising a part made from CMC composite material according to the disclosure.

In the present disclosure, the terms “axial”, “radial”, “tangential”, “inner”, “outer” and their derivatives are defined with respect to the main axis of the turbomachine; “axial plane” means a plane passing through the main axis of the turbomachine and “radial plane” means a plane perpendicular to this main axis; finally, the terms “upstream” and “downstream” are defined with respect to the circulation of the air in the turbomachine.

“Three-dimensional weaving” means a weaving technique in which weft threads circulate within a matrix of warp threads so as to form a three-dimensional array of threads according to a three-dimensional weave: all the layers of threads of a such fibrous structure are then woven during the same weaving step within a three-dimensional loom.

The aforementioned features and advantages, as well as others, will become apparent upon reading the detailed description which follows, of embodiments of the intermediate part and of the method proposed. This detailed description refers to the appended drawings.

### BRIEF DESCRIPTION OF THE DRAWINGS

The appended drawings are schematic and are primarily intended to illustrate the principles of the disclosure.

In these drawings, from one figure to another, identical elements (or portions of elements) are identified by the same reference signs. Furthermore, elements (or portions of elements) belonging to different embodiments but having a similar function are marked in the figures by numerical references incremented by 100, 200, etc.

FIG. 1 is an axial sectional view of a turbomachine.

FIG. 2 is a radial sectional view of a turbomachine ring.

FIG. 3 is a perspective view of a ring sector.

FIG. 4 shows a first example of a manufacturing method.

FIG. 5 is a perspective view of an example of an intermediate part.

FIG. 6 is a top view of the intermediate part of FIG. 5.

FIG. 7 is a radial sectional view of the intermediate part of FIG. 5.

FIG. 8 is a photograph of a green part.

FIG. 9 shows a second example of a manufacturing method.

### DESCRIPTION OF EMBODIMENTS

In order to make the invention more concrete, examples of the method and of the intermediate part are described in detail below, with reference to the appended drawings. It is recalled that the invention is not limited to these examples.

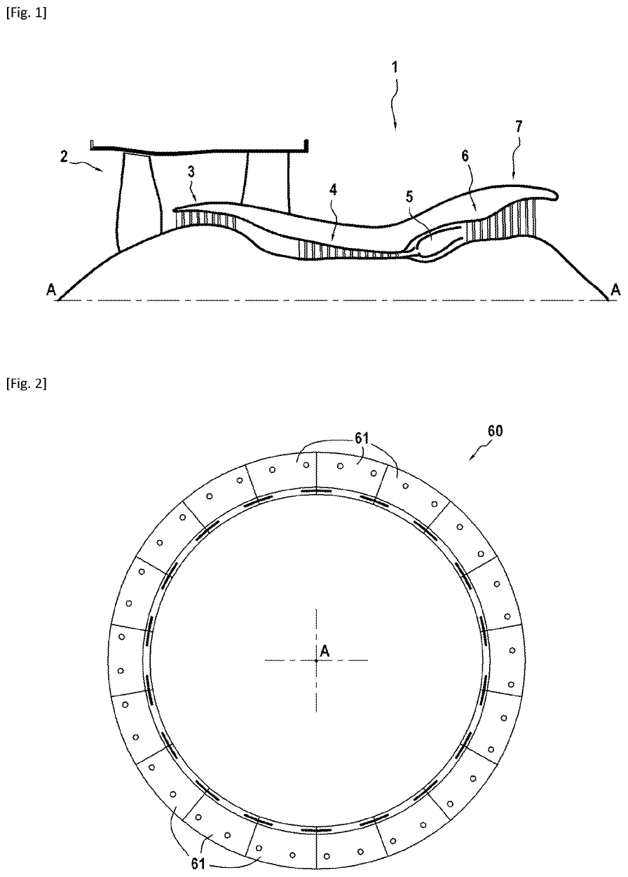

FIG. 1 shows, in section along a vertical plane passing through its main axis A, a turbofan engine 1 according to the disclosure. It includes, from upstream to downstream according to the circulation of the air flow, a fan 2, a low pressure compressor 3, a high pressure compressor 4, a combustion chamber 5, a high pressure turbine 6, and a low pressure turbine 7.

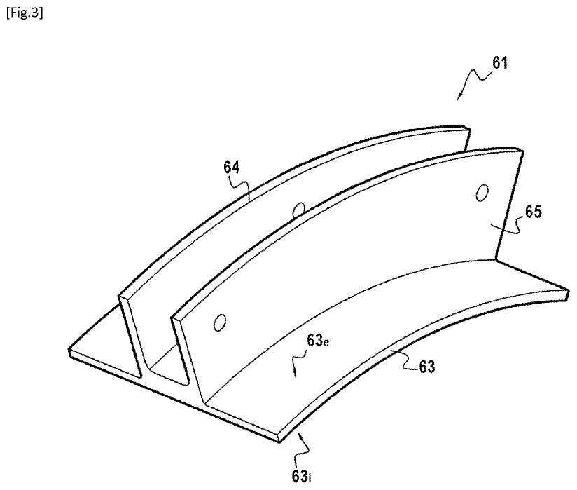

FIG. 2 illustrates the ring 60 of the high pressure turbine 6 defining the outer limit of the air flow path within the high pressure turbine 6. This ring 60 is divided into several sectors 61 made from CMC, which are substantially identical.

FIG. 3 illustrates such a sector 61: it comprises a flow path wall 63, an upstream flange 64 and a downstream flange 65. The flow path wall 63, having the shape of a cylinder sector, is configured to form, together with the other sectors 61 a cylindrical ring with axis A. The flow path wall 63 has an internal main face 63i, intended to delimit the air flow path, and an external face 63e. The upstream 64 and downstream 65 flanges extend radially outwards from the outer face 63e of the flow path wall 63: they are each placed in a radial plane of the ring 60.

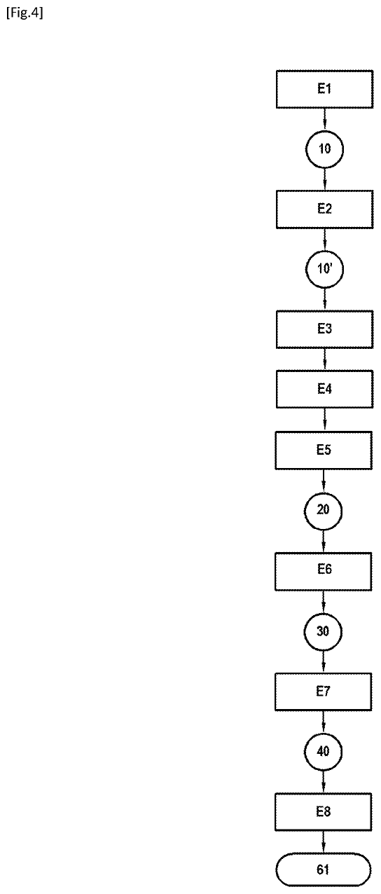

FIG. 4 illustrates the different steps of a first example of a method according to the description, allowing to manufacture such a ring sector 61 made from CMC, that is to say from a ceramic matrix composite material.

The method begins with the weaving E1 of a fibrous preform 10 which will play the role of fibrous reinforcement for the sector 61. This preform 10 is preferably woven according to a 3D weaving technique, also known, for example with an interlock type weave. In this example, the preform 10 is woven with silicon carbide (SiC) fibers.

Once the preform 10 is complete, it is shaped and undergoes an interphase deposition step E2, also known, for example of the chemical vapor deposition type (also known as CVD). In this example, the deposited interphase material is silicon carbide (SiC). A sheath of SiC is therefore formed around the fibers of the preform 10, which consolidates the preform 10 and blocks the shape given during shaping. At the end of this interphase deposition step E2, a consolidated preform is obtained, the fibers of which are coated with an interphase sheath; however, the consolidated preform 10′ still remains very porous.

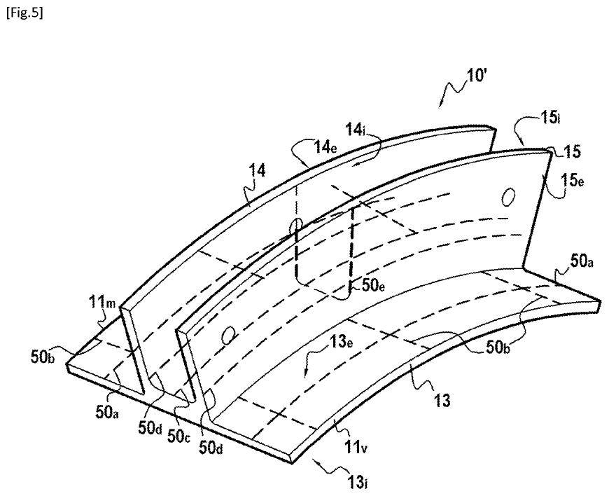

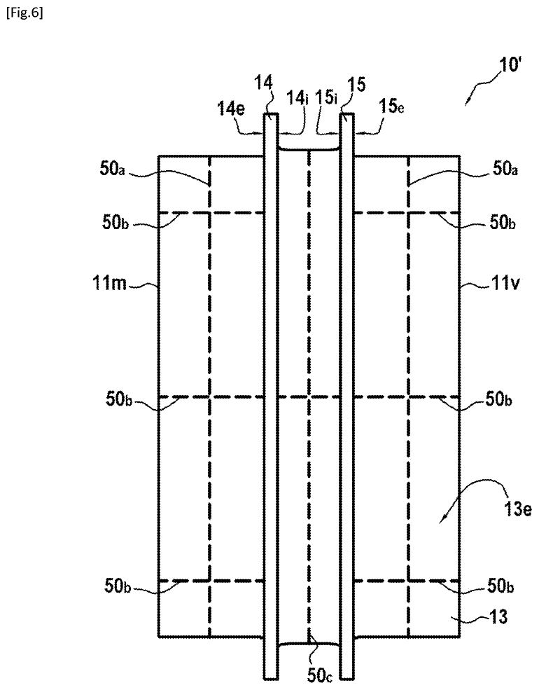

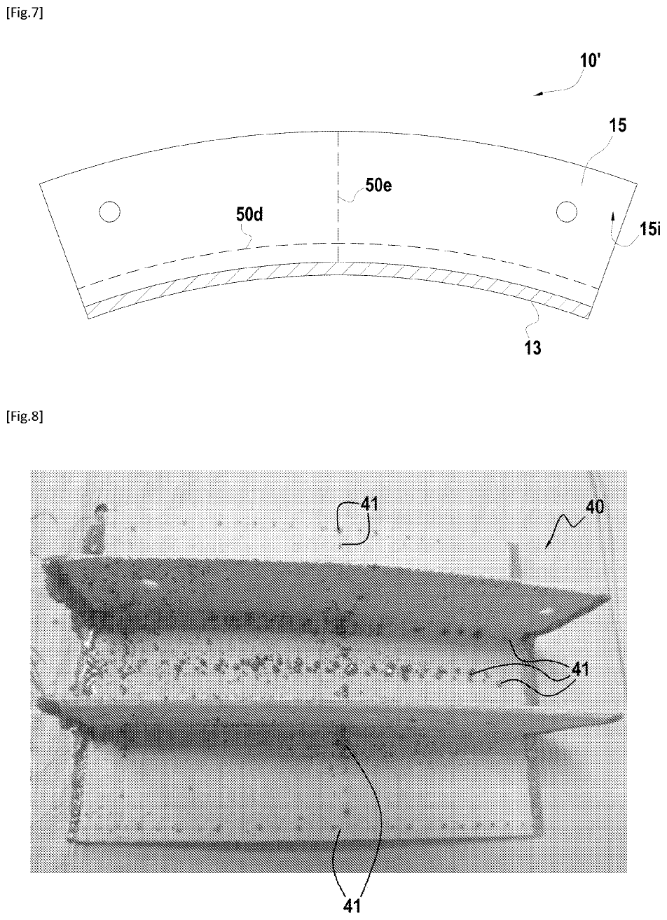

During a step E3, inserts 50a-50e are then placed on the surface of the consolidated preform 10′. These inserts 50a-50e, better visible in FIGS. 4, 5 and 6, are alumina threads (Al₂O₃) having a diameter of approximately 5 mm.

These inserts are disposed in an array extending exclusively on the outer face 13e of the wall 13 which will end at the flow path wall 63 of the ring sector 61, as well as on the side surfaces of the walls 14, 15 which will end at the upstream 64 and downstream 65 flanges of the ring sector 61.

Certain inserts 50a, 50c, 50d extending in the circumferential direction of the part, from one end to the other of the consolidated preform 10′. These circumferential inserts 50a, 50c, 50d cross other inserts 50b, 50e extending in the axial and/or radial directions of the part.

More specifically, in the present example, each lateral portion of the external face 13e of the flow path wall 13, that is to say each of the two portions extending between a flange wall 14, 15 and an axial end 11m, 11v of the consolidated preform 10′, is provided with a circumferential insert 50a and three axial inserts crossing the latter. These axial inserts 50b extend from the considered axial end 11m, 11v to the considered flange wall 14, 15: one of these inserts 50b is located in the middle of the sector while the other two run along a circumferential end of the sector.

The middle portion of the external face 13e of the flow path wall, that is to say the portion extending in the two flange walls 14, 15, is in turn provided with a circumferential insert 50c extending equidistant from the two flange walls 14, 15.

A circumferential insert 50d is also positioned at the base of each flange wall 14, 15, on the inner face 14i, 15i of the considered flange wall 14, 15, that is to say its face directed towards the other flange wall 14, 15.

Finally, a U-shaped insert 50e runs radially from the distal end of the upstream flange wall 14 along its inner surface 14i, then is oriented axially to run along the median portion of the outer face 13e of the flow path wall 13, then crossing the circumferential insert 50c, then is oriented again radially to join the distal end of the downstream flange wall 15 along its inner surface 15i.

It can then be noted that the inner face 13i of the flow path wall 13 has no insert. Similarly, the outer surfaces 14e, 15e of the upstream 14 and downstream 15 flanges, that is to say their surfaces facing the upstream 11m respectively downstream 11v end, of the consolidated preform 10′ also have no insert.

The preform 10′ thus consolidated and fitted with inserts 50a-50e is then transferred into a mold to undergo a step E4 of injecting a ceramic slurry. In this example, the slurry comprises a solvent, here water, a ceramic powder, here silicon carbide (SiC), and an organic binder, here polyvinyl alcohol.

In this example, the concentration of SiC powder in the slurry is about 20% by volume. The concentration of the binder is in turn 1% by mass relative to the mass of SiC powder in slurry.

The mold is in turn provided so as to match the shape of the preform 10′.

A drying step E5 is then carried out to remove the solvent from the slurry. This example involves a freeze-drying step, during which the mold is suddenly brought to a negative temperature in order to solidify the solvent then gradually heated at a very low pressure so as to bring about the sublimation of the solvent practically without altering the surrounding materials, the solvent in the gas phase then being removed using a cold trap for example. In another example, the drying could be carried out in an oven, with a temperature comprised between 60 and 110° C. In addition, the drying can be carried out in the mold or outside the mold.

During the drying step E5, within the preform 10′, the ceramic particles of the slurry settle and are deposited on the fibers of the preform 10′ as the solvent is removed, thus filling a share of the porosities of the preform 10′. A green part 20 is then obtained. However, in another example, the growth of the green part 20 can also be obtained by a filtration method during which one or more filters are contacted with the preform 10′ and retain the ceramic particles of the slurry.

The green part 20 thus obtained then undergoes an annealing and pre-sintering step E6 allowing to reinforce the connections between the particles of the ceramic powder and therefore to reinforce the strength of the green part 20.

In this example, the annealing takes place under an inert gas, for example argon, at a temperature of 1400° C. for 1 hour. An intermediate part 30 formed of a ceramic matrix enclosing the fibrous reinforcement 10′ and the inserts 50 is then obtained. However, in another example, the annealing could be done under vacuum; the temperature of the annealing can also be lower, at which the annealing extends over several hours.

Once this step E6 is completed, the intermediate part 30 undergoes a densification step E7. During this densification step E7, the intermediate part 30 is contacted with silicon Si, acting as a liquid densification material: the densification material then penetrates by capillarity within the intermediate part 30 and fills the remaining porosities of the intermediate part 30.

This densification step E7 is initiated at a temperature of 1450° C. then comprises a controlled cooling sub-step during which the temperature of the oven is gradually reduced, in a homogeneous manner, according to a ramp of 0.25° C./min, until reaching the final temperature of 1350° C.

During this step, the alumina Al₂O₃ forming the inserts 50a-50e volatilizes at least partially according to the reaction Al₂O₃<->Al₂O+O₂; the aluminum carried by the volatile sub-oxide Al₂O can then dissolve in the silicon, which releases oxygen from the part. The inserts 50a-50e thus leave room for channels which can be taken by the liquid silicon and in which the silicon is concentrated.

After cooling and solidification of the silicon, a green part 40 no longer, or practically no longer, having porosities is obtained. The green part 40, on the other hand, has nodules of solidified silicon 41. However, it can be seen in FIG. 8 that the areas where these nodules 41 appear correspond to the areas in which the inserts 50a-50e were located.

If desired, it is then possible to remove these nodules 41 during a machining step E8. Of course, other machining operations are also possible. In addition, certain faces of the ring sector 61, and in particular the internal main face 63i, can receive a thermal coating.

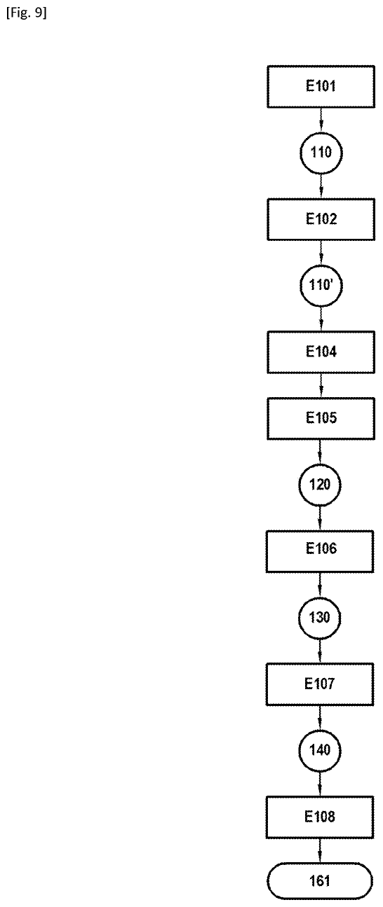

FIG. 9 illustrates a second example of a method allowing to obtain such a ring sector 161.

The method begins in the same way as the first example with the weaving E101 of a fiber preform 110. However, in this second example, the inserts are integrated from the weaving step E101.

In particular, the weaving strategy can provide for the simultaneous weaving of two types of fibers; reinforcing fibers on the one hand, made of SiC for example, forming the three-dimensional structure of the preform 110 and intended to form the reinforcement of the final part 161; and insertion fibers on the other hand, made of alumina for example, forming the inserts described above and intended to promote migration of liquid silicon during the densification step.

Once the preform 110 has thus been obtained, the remainder of the method is similar to that of the first example. The preform 110 undergoes an interphase deposition step E102, allowing to obtain a consolidated preform 110′ whose fibers are coated with an interphase sheath.

The preform 110′ thus consolidated is then transferred into a mold to undergo a step E104 of injecting a ceramic slurry then a drying step E105 in order to obtain a green part 120.

The green part 120 thus obtained then undergoes an annealing and pre-sintering step E106 allowing to obtain an intermediate part 130.

Once this step E6 is completed, the intermediate part 130 undergoes a densification step E107. During this densification step E107, the intermediate part 130 is contacted with liquid silicon Si which penetrates by capillarity within the intermediate part 130.

During a cooling sub-step, the alumina Al₂O₃ forming the inserts integrated into the preform 110 volatilizes at least partially and thus gives way to channels which can be taken by the liquid silicon and in which the silicon is concentrated.

After cooling and solidification of the silicon, a green part 140 having no more, or practically no more, porosities but on the other hand having nodules of solidified silicon is therefore obtained.

If desired, it is then possible to remove these nodules during a machining step E108 in order to obtain the final part 161.

Although the present invention has been described with reference to specific embodiments, it is obvious that modifications and changes can be made to these examples without departing from the general scope of the invention as defined by the claims. In particular, individual features of the different illustrated/mentioned embodiments can be combined in additional embodiments. Accordingly, the description and the drawings should be considered in an illustrative rather than restrictive sense.

It is also obvious that all the features described with reference to a method can be transposed, alone or in combination, to a device, and conversely, all the features described with reference to a device can be transposed, alone or in combination, to a method.

1. An intermediate part made from CMC composite material, having at least one working area intended, once the part has been finalized, to be in contact with a working fluid of a turbomachine, comprising
a reinforcement,
a matrix, including a ceramic material, and
at least one insert, which is made from a material different from that of the reinforcement and the matrix and having a diameter comprised between 0.1 and 1 mm and which is designed to promote migration of liquid silicon within the intermediate part during a step of densifying the intermediate part,
in which said at least one insert is provided in an area of the intermediate part that is not a working area.

2. The intermediate part according to claim 1, wherein at least one insert is a thread, a set of threads or a solid or hollow cylinder.

3. The intermediate part according to claim 1, wherein the length of at least one insert is greater than or equal to 5 mm.

4. The intermediate part according to claim 1, wherein at least one insert is partially or totally fusible or consumable during a step of densifying the intermediate part.

5. The intermediate part according to claim 1, wherein at least one insert has a coefficient of thermal expansion greater than that of the matrix.

6. The intermediate part according to claim 1, wherein at least one insert is made of oxide ceramic material.

7. The intermediate part according to claim 6, wherein at least one insert is made of alumina.

8. The intermediate part according to claim 1, wherein the reinforcement is a woven preform made of silicon carbide, and wherein the matrix is made of silicon carbide.

9. A method for manufacturing a CMC composite part, comprising the steps of:
providing an intermediate part according to claim 1; and
densifying the intermediate part by penetration of liquid silicon into the intermediate part.

10. The manufacturing method according to claim 9, wherein the step of providing the intermediate part comprises a step of weaving a preform, the weaving step comprising the simultaneous three-dimensional weaving of two types of fibers the materials of which are different, the first type of fiber forming the three-dimensional structure of the preform intended to form the reinforcement of the intermediate part and the second type of fiber forming at least one insert of the intermediate part.

11. The method according to claim 9, comprising, during the densification step, a sub-step of controllably cooling the intermediate part, and
a. in which a homogeneous temperature is imposed on the entire intermediate part during the cooling sub-step.

12. The method according to claim 11, wherein the cooling sub-step comprises at least one cooling ramp of less than 5° C./min.

13. A part made from CMC composite material, obtained by a manufacturing method according to claim 9.

14. A turbomachine, comprising a part made from CMC composite material according to claim 13.
